(19) United States
(12) Patent Application Publication
(10) Pub. No.: US 2026/0037556 A1
(43) Pub. Date: Feb. 5, 2026

(54) SEMANTIC MAPPING - LARGE LANGUAGE MODEL BRIDGING

(71) Applicant: Teradata US, Inc., San Diego, CA (US)

(72) Inventors: Paul Brown, Concord, MA (US); Vaikunth Thukral, South San Francisco, CA (US)

(73) Assignee: Teradata US, Inc., San Diego, CA (US)

(21) Appl. No.: 18/910,951

(22) Filed: Oct. 9, 2024

Related U.S. Application Data
(60) Provisional application No. 63/588,918, filed on Oct. 9, 2023.

(51) Int. Cl. G06F 16/3329; G06F 40/30

(52) U.S. Cl. CPC G06F 16/33295; G06F 40/30

(57) ABSTRACT

A system includes a storage device and at least one processor in communication with the storage device. The at least one processor receives a query associated with a plurality of data tables stored in the storage device. The at least one processor processes the query using a large language model (“LLM”) trained on semantic mapping information that describes relationships between data elements stored within the plurality of tables. The at least one processor generates, with the LLM, a natural language response to the query based on semantic mapping data generated from the data elements stored withing the tables. A method and computer-readable medium are also disclosed.

### CLAIM OF PRIORITY

This application claims the benefit of priority under 35 U.S.C. § 119(e) of U.S. Provisional Patent Application Ser. No. 63/588,918 filed on Oct. 9, 2023, which is hereby incorporated by reference herein in its entirety.

### BACKGROUND

As artificial intelligence (“AI”)-based applications increase in popularity, expectations that various types of technology be connected via AI and natural language processing increases. Analytic platforms that may include database management systems are no exception. High level data discovery techniques, such a semantic mapping, allow powerful knowledge gathering to occur through discovering data relationships across a data store. Large language models (“LLMs”) are an emergent approach to AI that focuses on natural language comprehension. The idea is that a large body of data made up of natural language text (Wikipedia, etc.) representative of how a particular language is used in practice be used as model input data. Commonly co-occurring words and utterances are tokenized. The output of what is referred to as the LLM “training phase” is equivalent to a probability distribution function over the tokens in the input data. The model produced by applying the training operation to the model input data allows users to make “probabilistic predictions” about the contents of the input model data. For example, given a sentence (or a sentence fragment) a LLM predicts the “next” utterance, or can complete the sentence fragment.

Base LLMs are categorized as “foundational models” that are a generic model that does not excel in a particular task. An important property of LLMs is that they can be further trained by introducing new text to a model already trained through various types of “fine tuning.” Such “fine tuning” allows LLMs to be used for more specialized tasks such as code generation in computer languages, or legal and medical questions. The idea is that a model is first pre-trained against common input model data, and then by supplying it with additional text, customize its responses to reflect knowledge in a particular problem domain.

Thus, it is desirable to establish an LLM capable of leveraging semantic mapping data to respond to natural language queries.

### SUMMARY

According to one aspect of the disclosure, a system may include a storage device and at least one processor in communication with the storage device. The at least one processor may receive a query associated with a plurality of data tables stored in the storage device. The at least one processor may further process the query using a large language model (“LLM”) trained on semantic mapping information that describes relationships between data elements stored within the plurality of tables. The at least one processor may further generate, with the LLM, a natural language response to the query based on semantic mapping data generated from the data elements stored withing the tables.

According to another aspect of the disclosure, a method may include receiving, with a processor, a query associated with a plurality of data tables stored a t storage device. The method may further include processing, with the processor, the query using an LLM trained on semantic mapping information that describes relationships between data elements stored within the plurality of tables. The method may further include generating, with the processor through the LLM, a natural language response to the query based on semantic mapping data generated from the data elements stored withing the tables.

According to another aspect of the disclosure, a non-transitory computer-readable medium may be encoded with a plurality of instructions executable by a processor. The plurality of instructions may include instructions to receive a query associated with a plurality of data tables stored in a storage device. The plurality of instructions may further include instructions to process the query using an LLM trained on semantic mapping information that describes relationships between data elements stored within the plurality of tables. The plurality of instructions may further include instructions to generate, with the LLM, a natural language response to the query based on semantic mapping data generated from the data elements stored withing the tables.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is an example of semantic mapping.

FIG. 6 is an example schema for semantic mapping that includes a signatures table and a signature pair table.

FIG. 7 is an example of a signature data object structure.

FIG. 8 is an example of database tables that have a relationship.

FIG. 9 is an example of large language model training (“LLM”) with semantic mapping information.

FIG. 10 is an example of an LLM executing a query using semantic mapping information.

FIG. 11 is an operational flow diagram of LLM training using semantic mapping information.

### DETAILED DESCRIPTION OF THE FIGURES

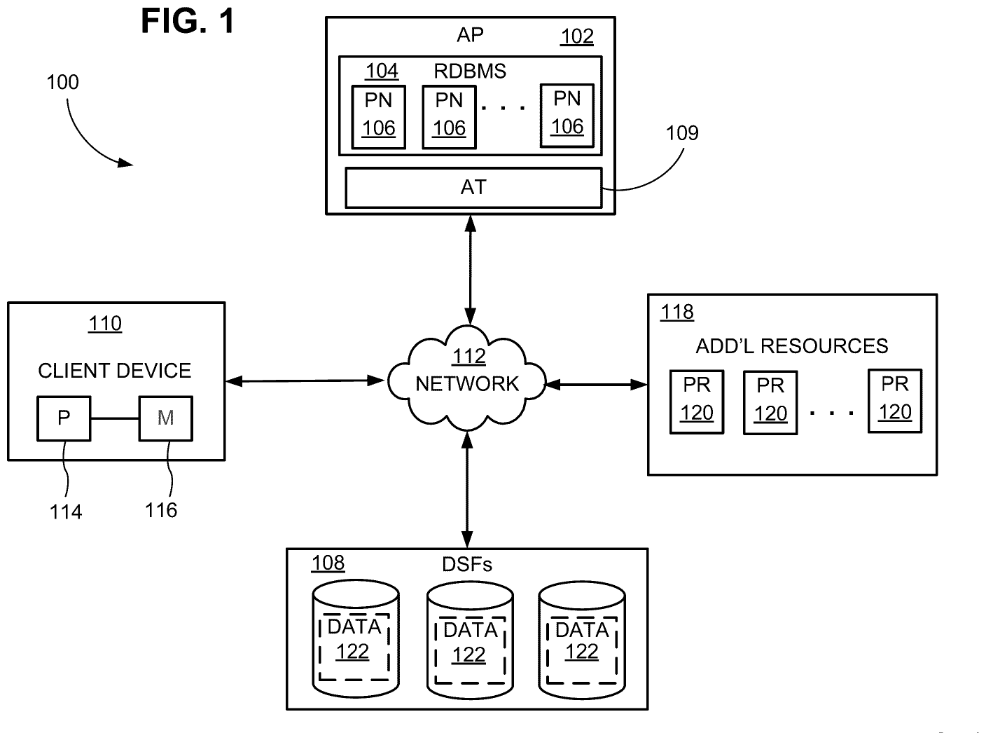

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in carrying out advanced analytics. The analytic platform 102 may include a relational database management system (“RDBMS”) 104. In one example, the RDBMS 104 may implement a parallel-processing environment to carry out database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

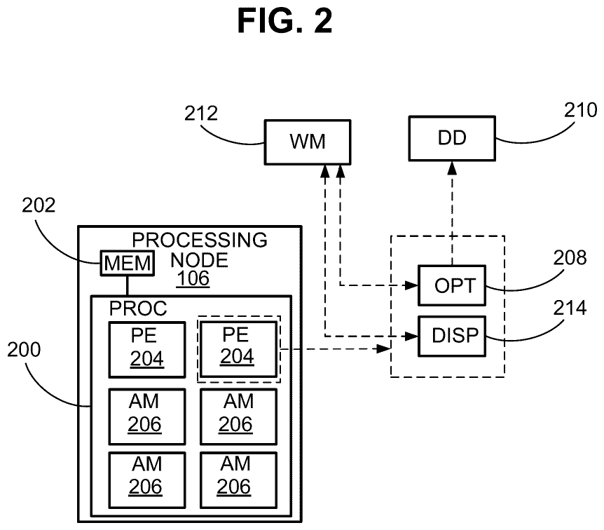

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

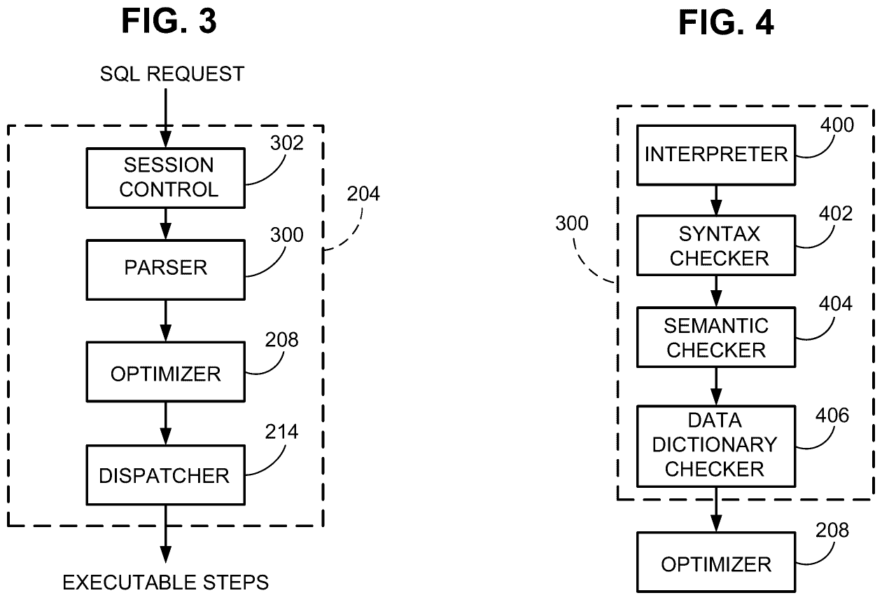

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

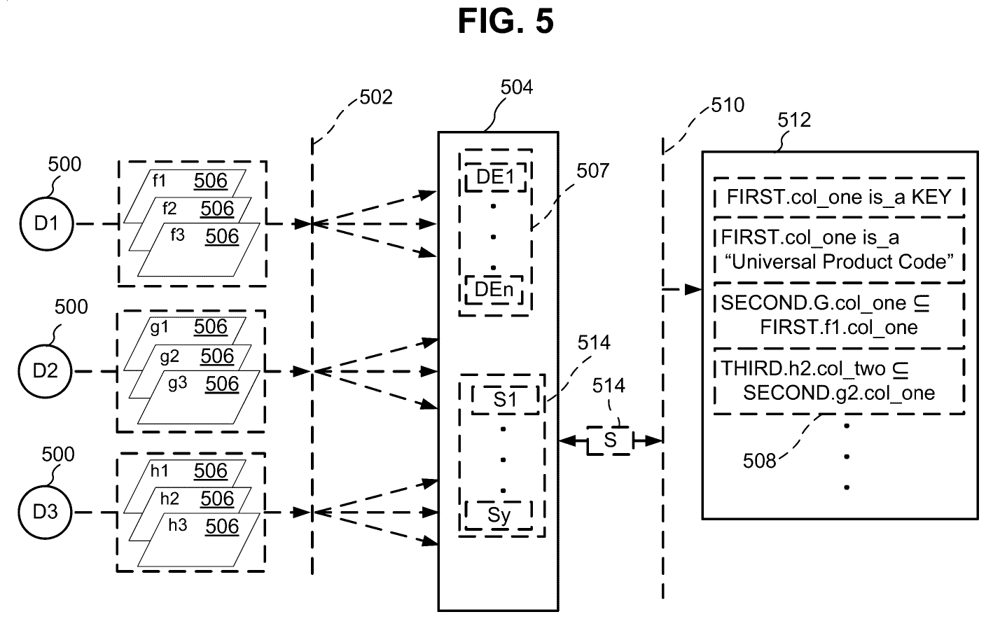

While data stored in the conventional manner may answer queries to a certain depth, without more precise data knowledge of the content of the data, answers may be limited. One manner of increasing this knowledge is to “map” at least a portion of data stored, which allows relationships between columns of different tables to be established. One manner of mapping is “semantic mapping”, which is described in U.S. patent application Pub. Ser. No. 18/149,105 entitled “SEMANTIC DATA MAPPING” and U.S. patent application Pub. Ser. No. 18/179,106 entitled “DATA OBJECT SIGNATURES IN DATA DISCOVERY TECHNIQUES”, which are hereby incorporated by reference herein in their entireties. FIG. 5 is a block diagram of overview of the inputs, intermediate data, and outputs, of a semantic mapping procedure. The “raw” inputs to the procedure are a dynamic collection of data sources 500 each of which corresponds to external applications and/or institutional providers of data. In FIG. 5, data sources 500 are individually designated as a DS1, DS2, and DS3. The number of data sources 500 in FIG. 1 is for exemplary purposes and the semantic mapping procedure is not limited to a particular number of data sources. A data source 500 may be the source of a collection of data. For example, a data source 500 may be an online application whose schema and data are subject to an extract-transform-load procedure, an IoT application, an application provided to the enterprise by a third party which provides its results as files in an object store, a named channel in a streaming service, static reference data maintained by some public authority, or data accessed through a distributed data gateway or federated data conduit. The semantic mapping tracks the data sources 500 because they are the ultimate source of data for every rule discovered during semantic mapping, which makes the data sources 500 important anchor points for supporting lineage/provenance and auditing. Initially, the semantic mapping procedure involves an ingest stage 502 that brings all of the data from the data sources 500 together into a unified, globally addressable name-space (e.g., a logical SQL database, JSON or XML, data store, or a data mesh/data fabric platform that leaves data in place but provides on-demand data access, etc.), which is referred to as a corpus 504. The corpus 504 conceptually represents the storage and organization of all data used for semantic mapping. Practically, the corpus 504 may be one or more systems used for data management, structuring, and analysis, such as data stores and/or analytic platforms.

In FIG. 5, a number of data sources 500 includes a number of data sets 506, individually designated as f1 through f3. A data set 506 may be ingested into the corpus 504 by first having its contents examined to ensure that its file structure (e.g., CSV, TSV, JSON, XML, etc.) is coherent and consistent, and secondly to create a data structure appropriate to the corpus 504 data management platform having an organization—naming labels, data types, etc.—that conforms with what is found in the ingested data set 506. In a SQL environment, each data set 506 may be manipulated to ensure it has a name that is unique within the corpus 504, column names to address the constituent data elements of the data set 506, and column data types (VARCHAR, INTEGER, FLOAT, DATE, ST_GEOMETRY, etc. for SQL, but other languages/structures apply). A data set 506 may be a bundle of data—file, stream, etc.—with a consistent internal format. A single data source 500 generates at least one data set 506. For example, an IoT application might provide a stream of data driven by a sensor on a production line logging objects as they pass and are organized into rows of fixed-width data values, or an official deeds and title records agency might provide a .csv file containing a weekly update of recent real estate transactions. A data source 500 may also generate multiple data sets 506. Typically, the original data in each data set 506 is provided in a some ‘raw’ form (e.g., UTF-8 or ASCII data in a basic .CSV or JSON format). In other examples, data may be ingested using different techniques allowing file-to-table transfer to occur in order to format date for semantic mapping that is not natively stored in table format.

Data sets 506 contain a number of named columns in a SQL environment. The term “element” may refer to the bag of “tokens” or “instance values” that may be addressed by/is associated with a “data set.data element” address, such as a table column in a SQL table. However, the term “data element” is not limited to SQL environments, but rather, represents an addressable component of a data set 506. In concrete terms, there is a data element 507 associated with the query SELECT “col_one” FROM “FIRST”.“a1”; The term “data element” 507 may be used rather than column because within a semantic map it is more accurate to describe data elements as abstract nodes of a rules graph. It is also useful to make the distinction between table columns and data elements because semantic mapping may be applied to derived data that is the result of some manipulation, such as a function applied to column data using a query.

From a starting point that consists of a unified namespace, one goal of the semantic mapping is to derive a list of rules 508 of the kind shown in FIG. 5. The rules 508 may describe rules regarding data elements 507 of a same data set 506 (e.g., that two data elements are peers within a data set 506) or between data elements 507 of different data sets 506. These rules may apply to single data elements 507 (e.g., when one element 507 of a data set 506 is a “key”), relationships between pairs of data elements 507 (e.g., values of one data element 507 are a subset of another data element 507) or apply to multiple data elements 507 (e.g., when a particular set of values appears multiple times in different data elements 507 within the corpus 504). From a theoretical perspective, these rules 508 are all propositions about the data in the corpus 504 expressed using set theory and first order predicate logic. For example, a rule may provide that “data element X of data set A functionally determines data element Y of the same data set” or “the data element X of data set A contains data values that are a subset of the data contained in data element Y of data set B.”

Such rules 508 make it possible to search the corpus 504—for example, to find all elements 507 that contain a set of values related to an initial set of search values by some rule 508—to contextualize a particular data set 506—by showing other data sets 506 associated with it through some rules 508—and to navigate between data sets 506—by following a chain of rules 508 possible through additional data sets 506 using data elements 507 with related values as a means of aligning their file structures.

A survey phase 510 may be included in the semantic mapping procedure. During the survey phase 510, a compact representation of the contents of data elements 507 is created, referred to as “signatures” 514, which are used to summarize the contents of each data element 507 in the corpus 504. Signatures 514 may be stored together with their related meta-data in an analytic/data-store-platform-appropriate schema that constitutes a compressed, specialized identification of the overall corpus 504. As shown in FIG. 5, data elements 507 (individually designated as D1 through Dn where n is the dynamic number of data elements 507) may be stored in the corpus 504 along with their signatures 514 (individually designated as S1 through Sy where y is the dynamic number of signatures 514).

The semantic map 512, which allows both search and navigation to identify data, consists of a body of rules 508. Each rule 508 corresponds to either some property of a data element 507 (e.g., that a data element 507 is a candidate key for its data set, which means that if a potential value is provided for that data element 507 at most one “row” should be found in the data set), some relationship between two data elements 507 (e.g., when the values in one are a subset of the values in another, or when some measure of statistical similarity exists between the value distribution of the two data elements 507), or some rule 508 about sets of data elements 507 (e.g., when the combination of two data elements 507 in a single data set 506 constitute a “key” even through each data element 507 on its own does not).

The rules 508 that make up the semantic map 512 may be considered a directed graph, with the nodes corresponding to data elements 507 and the rules 508 making up the edges. The simplest rules 508 may be structural. Such rules 508 rely on looking at the way the data set is organized. For example, if the data set is a .csv file then the two data elements in that data set 506 (two different columns in the .csv file) are considered “peers”. That is, for every row in the .csv data set there ought to be a value (or a NULL) in each data element 507. If the data set 506 has a hierarchical format, one data element 507 may be considered “dependent” on another because it comes from a lower branch in the hierarchy making it possible to address it relative to the “dominant” data element 507.

Due to the variable quality of raw source data and the approximate methods used, the evidence supporting the existence of these rules is inherently probabilistic. For example, an intuitive rule such as “data element SECOND.g2.col_one is a subset of data element FIRST.f1.col_one” corresponds to the more technically precise “P (x∈FIRST.f1.col_one|x∈SECOND.g2.col_one)>threshold”, and a rule 508 such as “data element FIRST.f1.col_one is a key for data set FIRST.f1” corresponds to the more precise, “The number of distinct values in data element FIRST.f1.col_one divided by the number of rows in data set FIRST.f1 is close to 1.0”. The “threshold” values, which determine the levels at which observed facts about relations between data elements 507 qualify as rules 508, are set via user application based on some examination of the entire semantic map 512 to work with the data in the corpus 504.

Other rules 508 may be derived from the more basic rules 508 described above. For example, the existence of inclusion dependencies can be inferred from the existence of multiple pairwise rules; “P (x∈FIRST.f1.col_one|x∈ANOTHER.currated.col_upc)>threshold”, and “P (x∈FIRST.f1.col_one|x∈YET_ANOTHER.currated.col_upc)>threshold”, etc. Similarly, a rule 508 such as “SECOND.g2.col_one is a foreign key referencing FIRST.f1.col_one” may be inferred from the rules 508 characterizing “FIRST.f1.col_one is a Key”, and “SECOND.g2.col_one is a subset of FIRST.f1.col_one”. Structural and probabilistic rules 508 can also be combined to produce Functional Dependencies. For example, knowing that “FIRST.f1.col_one as a key”, it follows that “FIRST.f1.col_one determines FIRST.f1.col two”. Finding basic rules 508, based on the data in data elements 507 and the structure of data sets 508 is the fundamental task of the semantic mapping procedure.

One of the ways rules 508 are used involves automatically “tagging” assigning a descriptive label (or labels) to a data element 50). For example, following on from the domain rule discovery introduced above, once “FIRST.f1.col_one” is known to be a “domain” (700), user-based-input may supply a domain label (702). This is the first place where semantics (that is, some “labels and meanings”) become a part of the semantic map 512. All such domain labels are the consequence of user-based input; the answer a user may provide when the semantic mapping procedure asks them, “Data that looks like this {v₁, v₂, . . . vₙ} seems to occur frequently in the corpus 504. Can you provide a label?” Domain labels are analogous to a symbols key in a cartographic map. Having labelled such a domain (702), the corpus 504 can be searched to find all data sets 508 that contain an element 507 associated with a domain label. The semantic mapping procedure, in isolation, is a mechanism for determining rules such as set theoretic properties of data elements 507 within the corpus 504. But given guidance in the forms of domain labels, or curated data sets, user contribution may be reduced significantly. This approach of tagging large collections of data elements 507 that all comply with some rule is in contrast with other forms of “tagging” where tags are applied to one data element 507 or one data set 506 at a time.

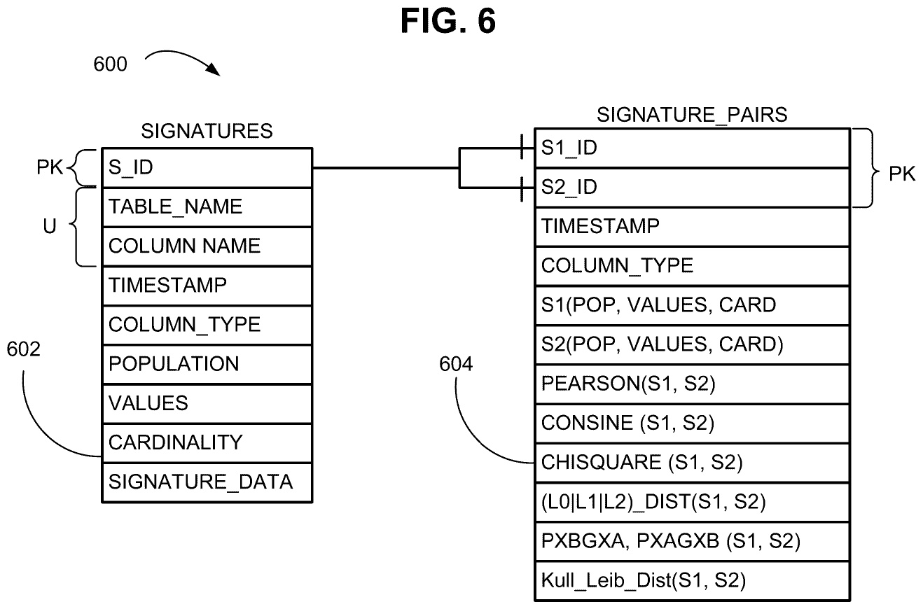

FIG. 6 is an example schema 600 that may be used for semantic mapping that includes a SIGNATURES table 602 and a SIGNATURE_PAIR table 604. Note that, for example, the COLUMN_TYPE, ROW_COUNT, VALUE_COUNT and DISTINCT_COUNT values of the SIGNATURES table 602 can all be extracted from the SIGNATURES.SIGNATURE_DATA column 602, and all of the values (e.g., population in the SIGNATURE_PAIRS table 1004 either repeats information from the SIGNATURES table 602 or else may be calculated by comparing the SIGNATURE_DATA table 604 entries from the corresponding entries in the SIGNATURES table 602 with user-defined functions. The decision about what to materialize and what to calculate is a physical tuning question beyond the scope of this disclosure.

Table 1 below describes the correspondence between elements of the schema in FIG. 6, and components of a semantic mapping procedure.

TABLE 1
Columns of the SIGNATURES Table in the Semantic Mapping Repository Schema

| Schema Element | Relationship to Semantic Mapping Procedure |
|---|---|
| S_ID | None. This is simply a surrogate key meant to clarify the |
| | relationship between the SIGNATURES table 1002 and the |
| | SIGNATURE_PAIRS table 1004. |
| DATA_SOURCE | Identity of the data source 100 from which the data set 106 and the |
| | individual data element 507 was ingested. |
| DATA_SET_NAME | Name of the data set 106 in the corpus 104 that contains the data |
| | element 507 from which the procedure derives the |
| | SIGNATURE_DATA table 1002 entries. |
| DATA_ELEMENT_{—} | Name of the data element 507 within the data set 106 from which |
| NAME | the procedure derives data from the SIGNATURE_DATA table |
| | 1002. Note that the combination of TABLE_NAME and |
| | COLUMN_NAME constitute a candidate key for the |
| | SIGNATURES table 1002. The information in these columns may |
| | be used to cross reference signatures 514 with the contents of the |
| | corpus 504. |
| TIMESTAMP | Date and time (or version number) at which the semantic mapping |
| | procedure analyzed the data element 507 in the corpus 104 to |
| | produce and store entries in the SIGNATURE_DATA table 1002. |
| | This column's information provides the basis for the provenance or |
| | history of this analysis. In more elaborate schemas a more complete |
| | history would need to be stored. Captured (recorded) in Steps 1 and |
| | 2. |
| COLUMN_TYPE | Data type of the data element. Captured during the ingest |
| | procedure. |
| POPULATION | Number of rows in the data set 507. This data is added or updated |
| | during the survey operation. |
| VALUES | Number of non-NULL (e.g., not “missing”) values in the data |
| | element. This will always be less than or equal to the number in the |
| | associated POPULATION column. This data is added or updated |
| | during the survey. |
| CARDINALITY | The number of distinct values in the data element 507. This will |
| | always be less than or equal to the number in the associated |
| | VALUES column. This data is added or updated during the survey. |
| SIGNATURE_DATA | The result of the survey. This will be a data object (e.g., user- |
| | defined type) created by the survey (or possibly during ingest). The |
| | contents of these data objects can be interrogated to make |
| | determinations such as that of the previous three values in Table 1 |
| | or compared (the compare phase of the procedure) to populate |
| | columns in the SIGNATURE_PAIRS table 604. This data is added |
| | or updated during the survey and used during the mapping to derive |
| | rules about the corpus. Note that COLUMN_TYPE, |
| | POPULATION, VALUES, and CARDINALITY may be calculated |
| | from the SIGNATURE_DATA. |

The SIGNATURES table 602 may be populated during the ingest operation once a data source 500 has been identified. As data is examined during the ingest operation, each data element 507 can be surveyed with the survey operation, a process that can be performed in parallel (for scalability) and within the same software platform where the corpus data, and the semantic mapping repository will be stored. That is, this table may be populated by a single application that combines the ingest and survey procedures of the detailed procedure above. As new data is appended or ingested to the corpus 504, the survey and mapping procedures can use the TIMESTAMP to distinguish new from old data and to determine which rules may need to be checked in the light of new data.

Contents of the SIGNATURES_PAIRS table 604 are derived during the mapping of the semantic mapping procedure. That is, the SIGNATURE_PAIRS table 604 is populated during mapping, with computational majority being done as part of signature comparison(s), and the features in an analysis being produced using SQL queries or SQL views over these two tables.

What each row in the SIGNATURE_PAIR table 604 records is that there is some relation between the data values associated with two data elements 507. But the categorical nature of this relationship (e.g., when the values in one data element 507 contains a subset of the values in the other, or when one data element 507 has the same range of values exhibiting the same statistical distribution as the values in the other) is not recorded explicitly. Rather, each row in the SIGNATURE_PAIRS table 604 records some probabilistic, mathematical, or statistical evidence. Any decision about the existence of some categorical rules is made by the user when they specify a threshold value during an analyze procedure. An important point to make is that getting to the rows in the SIGNATURE_PAIR table 604 is going to involve rejecting the vast bulk of the extremely large number of candidate pairs implied by comparing each signature 514 of a data element 507 with all other signatures 514 of the data elements 507. Efficiently detecting and rejecting highly-improbable candidates is key to the efficiency of the mapping of the semantic mapping procedure. The analysis requires writing queries over this schema to discover things like domains, keys, etc. We present the way keys and key/foreign key relationships are inferred below.

A (single column or single data element 507) key occurs when the cardinality of the values in the data element 507 (e.g., the number of unique values) approaches the population of its data set 506. In other words, a column (of a file or otherwise unconstrained table) is a key when searching that column using a (possible) value will identify at most one row in the data set. The nature of the data dealt with and features of the process mean that on a simple inequality to determine when a column is a key cannot be relied upon. The underlying data may be of poor quality, that is, the original data source file can contain a few values which violate the key constraint. And the value of the cardinality derived from the Signature object is an estimate, albeit one of known and narrow error bars. Consequently, a calculation some measure of “keyness” is required and a filtering of candidate data elements 507 that fall below some threshold for this metric.

TABLE 2
Columns of the SIGNATURE_PAIRS Table

| Schema Element | Relationship to Semantic Mapping Procedure |
|---|---|
| S1_ID, S2_ID | Columns that are foreign keys relating the entry in |
| | SIGNATURE_PAIR table with the entry in the SIGNATURES |
| | table. The pair of these columns constitute the key of the |
| | SIGNATURE_PAIR table. |
| TIMESTAMP | Date and time (or version number) at which the semantic mapping |
| | procedure 200 analyzed the pair of signatures 514 and populated |
| | this row. This column is a placeholder for implementing the |
| | provenance (history) functionality required by the overall |
| | semantic mapping procedure. |
| COLUMN_TYPE | Data type of both data elements 507 compared to produce this |
| | row. |
| S1 { POP, VALUE, | The POPULATION (row count), VALUE count (count of non- |
| CARD } | null values) and CARDINALITY (count of distinct values) in the |
| | the S1 data element 507. |
| S2 { POP, VALUE, | The POPULATION (row count), VALUE count (count of non- |
| CARD } | null values) and CARDINALITY (count of distinct values) in the |
| | the S2 data element 507. |
| PEARSON, COSINE, | Measures of statistical or information theoretic distances between |
| CHISQUARE, | the values in the pair of data elements 507 S1 and S2. |
| Kullback_Leibler and | |
| Jensen_Shannon | |
| divergences. | |
| PXAGXB, PXBGXA | Measures of conditional probabilities of values being shared by |
| | the two data elements S1 and S2. These correspond to P ( x ∈ S1 \| |
| | x ∈ S2 ) and P ( x ∈ S2 \| x ∈ S1 ) respectively. |

With regard to signatures 514, an important point to note at the outset about is that their content may vary depending on the nature of the data in the data element 507 from which they were constructed. For example, it is possible, given the design of the signature 514, to include a complete frequency distribution of the values of a data element, which makes it possible to estimate statistics such as cardinality, or to compare the contents of two data elements 507 for set-theoretic relationships with absolute precision. Once the size of the data required to hold the frequency distribution exceeds some pre-configured threshold (e.g., 48 KB) the data object shifts to a combination of a kind of minHash data structure and a simple random sample. From the combination of these precise estimates of statistics such as cardinality of the data element 507 and properties of the values (mean, variance, statistical distribution) and comparisons between pairs of bags of values (statistical tests, information theoretic distances, other comparison metrics) may be arrived at. The overall goal of the design of a signature data object is to pack as much information about tokens/instance values in a data element 507 into each signature 514 as is possible.

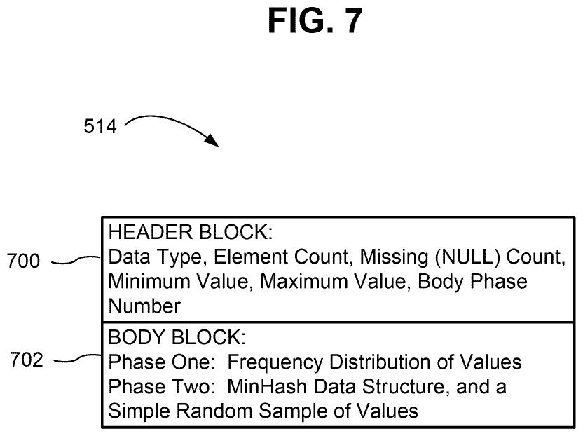

An example of a signature 514 is shown in FIG. 7. Recall that during survey operations, the data in each data element 507 is broken down into partitions and gather a per-partition survey before merging the per-partition signature data objects to arrive at an overall signature 514 for the entire data element 507. In creating the per-partition signatures, a signature data object 514 may be created at the time the survey begins, which means memory is allocated for the signature 514 in each partition of the data of the data element 507. This can sometimes be a small number of tens of KB: for example, 48 KB. The header block 700 of the signature 514 is typically a few tens of bytes and at initialization time is populated with the information about the data element 507 data type. This information is carried by each signature 514 through the survey and mapping.

For each “value” (recall that a “value” may be a NULL token or some other kind of “missing information” reference), the survey may:
1. Increments the “Element Count” of the header block 700.
2. Checks to determine whether this “value” is a NULL or missing code, and if so, increments the Missing (NULL) Count.
3. Otherwise, checks to determine whether the “value” falls outside the Minimum Value to Maximum Value range, where necessary adjusting the range to include the new “value”.
4. If the signature 514 is operating in phase one (that is, if the Signature Body consists of a frequency distribution), attempt to update the Frequency Distribution either by locating this “value” and incrementing the count, or else by adding a previously unseen “value” to the data structure.
5. If the addition of the new “value” would result in a frequency distribution data structure that is too large (recall that all signatures 514 are restricted to some upper bound of memory), then convert the body block 702 to Phase Two organization. If the new “value” fits into the Phase One organization, proceed to the next “value” from the data element.
6. The Phase Two organization of the signature body block 702 has two components:
   a. A minHash data structure that can be used to estimate single data element 507 statistics such as cardinality, and pairwise relationships such as the size of an intersection or the size of the union of the two.
   b. A simple random sample of the values in the data element 507 that can be used to estimate single data element statistics such as mean and median, as well as pairwise statistical relationships by comparing the two sample distributions.
      When the signature 514 is in Phase Two while the data element 507 is being surveyed, each additional “value” may update either the minHash structure, or the simple random sample, or neither (if the value has been seen before and the random sample algorithms does not require that it be recorded), or both.

Once all of the values in at least two partitions have been surveyed, the per-partition signature objects may be merged so as to produce a signature 514 that is the equivalent—for the purposes of estimating the statistical results needed by the map procedure—of one that would have been produced by surveying all of the values in both partitions as a single signature result.

The approach to merging header blocks 700 is straightforward. Merging the body block 702 may be more involved, as it may require to progress one, or the other, or both data structures through their phases. For example, in merging two signature objects S1 and S2:
If S1 and S2 are both in Phase 1 (are both frequency distributions) then we can proceed by taking each element (that is, each {value, count} pair) in the smaller of the two (say S1) and appending them to the Body Block of the larger (say S2). During this kind of merge, of course, the S2 Data Block may transition from Phase 1 to Phase 2.
If either S1 or S2 are in Phase 1 (say S1) but the other is not (say S2), then the approach is to take each {value, count} pair from the Phase 1 signature in S1 and append them to the Phase 2 data block in S2.
If both S1 and S2 are in Phase 2, then merging the minHash and the Simple Random Sample separately is needed. The procedure for merging minHash and samples is straightforward and well known in the art.

Starting with two partitions (that is, disjoint subsets) of the data in a data element 507, which for example are DE₁ and DE₂, then the implementation of the signature survey needs to guarantee that survey (DE₁∪DE₂) is equivalent to MERGE (SURVEY (DE₁), SURVEY (DE₂)) for the purposes of signature COMPARE to make the kinds of estimates we list below.

The kinds of comparisons we can make between the values in data elements 507 are estimates based on comparisons between per-data element signatures 514. The following table is a non-exhaustive list of functions that can be applied to a single signature 514 or pairs of signatures 514, passed as arguments.

TABLE 3
List of Functions and Comparisons Computable from the Signature Objects

| Function Name | Description |
|---|---|
| Signature_to_JSON | Given a signature type value, create a JSON text object that |
| | reports the information in it. |
| Population | Report the number of tokens that were found on the data |
| | element 507 and used to compile this signature 514. Note |
| | that this includes NULLs. |
| Null_Count | Report the number of NULL or missing tokens that were |
| | found on the data element 507. This means that the number |
| | of real values in the signature 514 is Population( ) - |
| | Null_Count( ). |
| IsSurrogate | Used to report when the signature data is a surrogate or |
| | synthetic key. Mechanically, this means (a) the type is |
| | integer, (b) the value range starts at 0 or 1, (c) the range of |
| | values between min Value and maxValues more or less |
| | accounts for every distinct value in the original data element |
| | 507. |
| Count_Estimate | Distinct count estimation for the number of tokens in the |
| | data element 507 used to compile the signature 514. |
| DC_Estimate_Method | Reports whether or not the signature sample is exact or |
| | approximate. That is, this function reports the signatures's |
| | 514 Phase (1 or 2). |
| Overlaps | Given two signatures 514 (of the same type), if they do not |
| | overlap (determined by their max and min values) then |
| | return a negative number. Otherwise return a positive |
| | number that reflects the kind of overlap. |
| P_XAGXB | Given two signature 514, what is the probability that a value |
| | x appears in the first signature 514, given that x appears in |
| | the second signature 514. |
| P_XBGXA | Given two signatures 514, what is the probability that a |
| | value x appears in the second signature, given that x appears |
| | in the first. |
| L0Dist | Given two signature s, create a pair of normalized |
| | histograms from the samples, and calculate the L0 distance |
| | between the normalized histograms. |
| L1Dist | Given two signature 514, create a pair of normalized |
| | histograms from the samples, and calculate the L1 distance |
| | between the normalized histograms. |
| L2Dist | Given two signatures 514, create a pair of normalized |
| | histograms from the samples, and calculate the L2 distance |
| | between the normalized histograms. |
| ChiSquare | Given two signatures 514, create a pair of normalized |
| | histograms from the samples, and calculate the Chi_Square |
| | distance between the distributions found in the normalized |
| | histograms. |
| Cosine | Given two signatures 514, create a pair of normalized |
| | histograms from the samples, and calculate the Cosine |
| | distance between the distributions found in the normalized |
| | histograms. |
| Pearson | Given two signatures 514, create a pair of normalized |
| | histograms from the samples, and calculate Pearson |
| | Correlation between the distributions found in the |
| | normalized histograms. |
| Kullback_Leibler | Given two signatures 514 which we will call S1 and S2, use |
| | the samples to create a pair of Probability Distribution |
| | Functions we will call P and Q and then compute the |
| | Kullback-Leibler divergence, which is an information |
| | theoretic measure that quantifies by how much one |
| | probability distribution differs from the other probability |
| | distribution. |
| Jensen_Shannon | Given two signatures 514 (S1 and S2) use the samples to |
| | create a pair of Probability Distribution Functions we will |
| | call P and Q and then compute the Jensen-Shannon |
| | divergence which is a symmetrized and smoothed version |
| | of the Kullback-Leibler divergence. Other statistical and |
| | information theoretic tests and distance/divergence methods |
| | can be added that will rely on the contents of the signatures |
| | 514. |

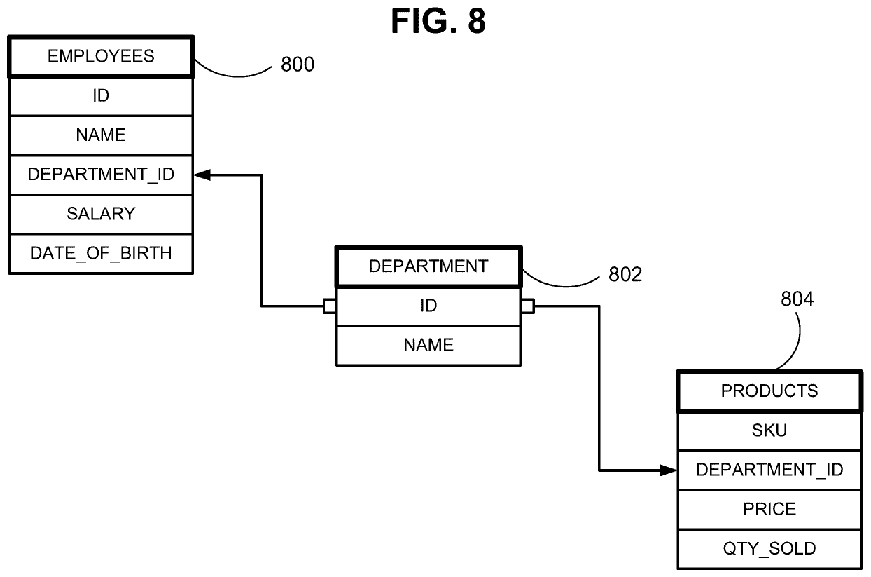

AI-driven techniques may be implemented in the analytic platform 102 allowing more advanced analytic performance to take place. While artificial intelligence (“AI”) generally provides a manner in bringing complex questions to be made into natural language form, an AI-based system is only as good as the data and the manner in which it is trained. For example, in FIG. 8, a relationship is shown between three tables “Employees” table 800, “Department” table 802, and “Products” table 804. With standard data knowledge, statements such as the following may be made based on the relationships between the tables:
“A column ‘ID’ is found in table ‘Employees’ and is a key.”
“A column ‘Name’ is found in table ‘Employees’.”
“A column ‘Department_ID’ is found in table ‘Employees’.”
“A column ‘ID’ is found in table ‘Department’.”
“A column ‘Name’ is found in table ‘Department’.”
“Column ‘Name’ found in table ‘Employees’ contains ‘People Names’.”
   However, with semantic mapping additional knowledge is obtained, where statements such as the following may be made based on the discovery of the additional knowledge:
“Values in column ‘Department_ID’ found in table ‘Employees’ are a subset of values in column ‘ID’ found in table ‘Departement’.”
“Column ‘Department_ID’ found in table ‘Employees’ is a foreign key dependent on column ‘ID’ found in table ‘Department’.”
“Column ‘Date_of_Birth’ found in table ‘Employees’ contains ‘Calendar Dates’.”

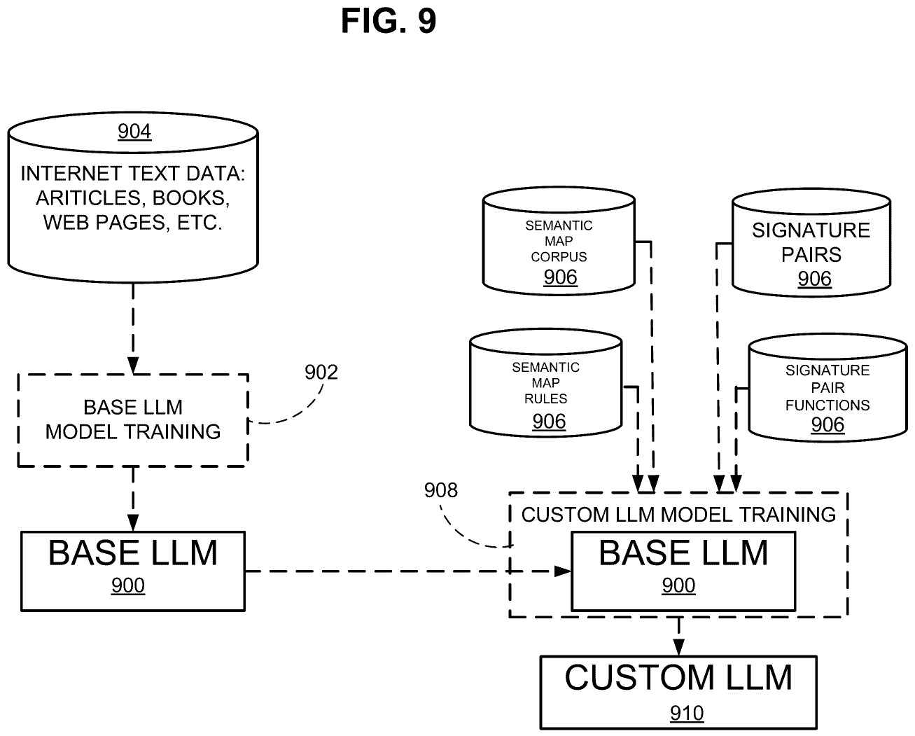

In one example, a large language model (“LLM”) may be trained to allow a “chat bot style” to occur between user input and the LLM. Although many pre-trained models are mostly static (i.e., GPT-4 used by the popular ChatGPT), LLMs may be further trained on domain-specific data. FIG. 9 is an example of training an LLM to provide enhanced database knowledge in a natural language format. A base LLM 900 may be generated through model training 902 using general internet training data 904. Various methods may be used in model training 902 to train an LLM, such as through self-supervised learning process, supervised learning process, and/or reinforcement learning process, which allows an LLM to acquire its abilities by learning statistical relationships from vast amounts of text during the learning processes. The general internet training data 904 may contain various resources such as articles, books, web pages, or any other informational resource that may be found on the internet. As previously mentioned, while general internet information is sufficient enough for some LLMs, this information is too limited and/or inaccurate to generate an LLM for domain-specific tasks. Once the base LLM 900 is created, domain-specific training data 906 may be used to generate a custom LLM 908 via custom LLM model training 910.

The custom LLM 910 allows domain-specific queries to be made on a dataset using providing relationship knowledge regarding a dataset being queried on via semantic mapping information. The domain-specific training data 906 may be “validated” and “labeled” and consist primarily of the corpus 504 of the semantic map, signature pairs, signature pair tables, and signature pair functions (see Table 3).

The training of the custom LLM 610 causes natural-language sentences to be generated by using the underlying statistics created through semantic mapping to make evaluations of the closeness and types of relationships the columns of different tables across the entire corpus 504. For example, by using information about the row counts and distinct counts, a deduction may be made as to whether a column is a foreign key to another column. Likewise, using the cosine, chisquare and other distance metrics in the semantic mapping tables, it is possible to make assertions whether a column has a “small”, “similar” or “identical” overlap in the values in pairs of columns across the tables.

Using this methodology of the sentence creation, it is then possible to create a dictionary that contains, in natural language, all the possible types of relationships across all columns in the complete set of tables which have been evaluated. This dictionary can be quite sizeable and is then introduced to a typical “retrieval augmented” LLM stack.

The plain text information in the dictionary may be embedded and stored into a vector database. This may be done via existing tools available in the analytic platform. This is the stage of “fine tuning” an LLM. There are multiple options available here as to how information in this dictionary can be exposed to the LLM API. For example, typical options of RAG (Retrieval Augmented Generation) based system are available, wherein the constructed dictionary may be split into multiple chunks to be stored and retrieved through a vector database. Another option is to perform the search of relevant data locally, and the decision to pick one over the other can be based on performance requirements. In addition, more options exist via fine-tuning methods of LLMs to update the model weights directly, so as to embed the knowledge in the dictionary directly into the LLM instead of shipping it with a prompt. Within fine-tuning as well there are many approaches beyond the scope of this disclosure, but any of these methods may suffice to implement this specialized relationship-based data in the text-based dictionary.

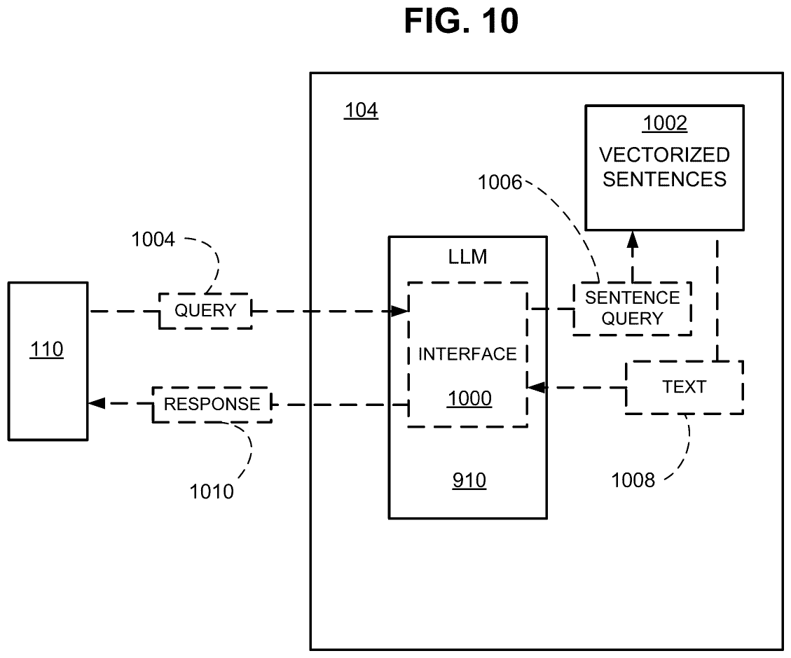

FIG. 10 is an example of a chat-bot interface that may be used to respond to input from the client device 110 (or other user devices configured to communicate with the analytic platform 102). As shown in FIG. 10, the custom LLM 910 may operate within the RDBMS 104 and provide an interface 1000 between the client device 110 and the capabilities of the RDBMS 104. As shown in FIG. 10, a vectorized dictionary 1002 may exist and be stored within the RDBMS 104, such as in the data dictionary 210. The chatbot interface 1000 may be used by the LLM 910 to interact with the client device 110 (and other suitable devices). In one example “in-context” learning may be used to have the LLM 910 return useful answers to the client device 110, which may be performed through a semantic search. Once a client device 110 provides a query 1004 about a certain table, vectorized dictionary 1002 may be queried by the LLM 910 (sentence query 1006) to get matches about the particular table or column(s) of interest. Then, an appropriate text chunk 1008 is fetched from the vectorized dictionary 110, which becomes part of the prompt that is sent to the LLM interface 1000 and returned as response 1010 to the client device 110. In this way, the customized LLM 910 then becomes knowledge aware of the contents of the particular tables and columns and their relationships and may answer questions about the same.

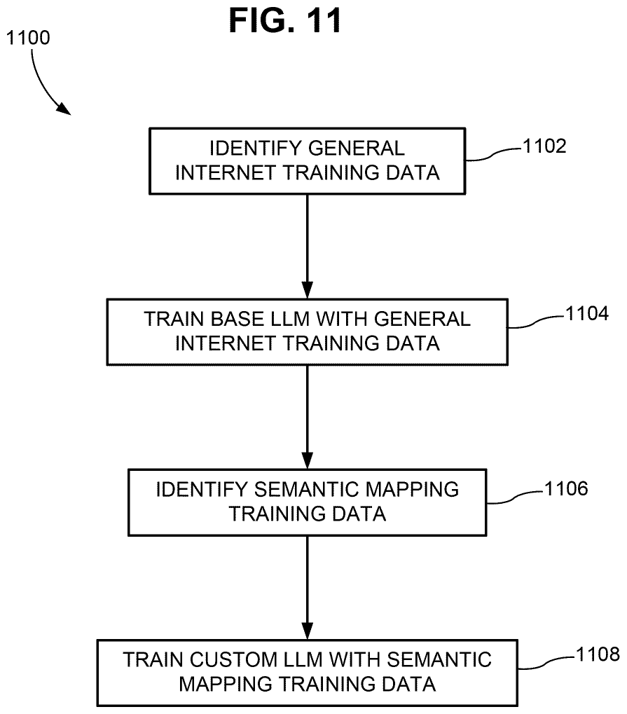

FIG. 11 is an operational flow diagram of an example LLM training 1100. In one example, general internet training data may be collected for an LLM (1102). The LLM may be trained with the general internet training data (1104). The semantic mapping data may be identified to customize the LLM, such as the base LLM 900 (1106). The base LLM 900 may be trained using the semantic mapping data (1108), such as that described with regard to FIG. 6.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

We claim:

1. A system comprising:
a storage device;
at least one processor in communication with the storage device, the at least one processor configured to:
receive a query associated with a plurality of data tables stored in the storage device;
process the query using a large language model (“LLM”) trained on semantic mapping information that describes relationships between data elements stored within the plurality of tables; and
generate, with the LLM, a natural language response to the query based on semantic mapping data generated from the data elements stored withing the tables.

2. The system of claim 1, wherein the semantic mapping data is stored as a plurality of text phrases, and wherein the at least one processor is further configured to:
retrieve, with the LLM, in response to content of the query, a portion of the text phrases; and
generate, with the LLM, natural language sentences based on the retrieved portion of the text phrases.

3. The system of claim 2, wherein the plurality of text phrases is stored as vectorized text phrases.

4. The system of claim 1, wherein the semantic mapping information comprises at least one of: a semantic map corpus, semantic map rules, signature pairs, and signature pair functions.

5. The system of claim 1, wherein the LLM is executed within a relational database management system.

6. A method comprising:
receiving, with a processor, a query associated with a plurality of data tables stored in a storage device;
processing, with the processor, the query using a large language model (“LLM”) trained on semantic mapping information that describes relationships between data elements stored within the plurality of tables; and
generating, with the processor through the LLM, a natural language response to the query based on semantic mapping data generated from the data elements stored withing the tables.

7. The method of claim 6, wherein the semantic mapping data is stored as a plurality of text phrases, wherein the method further comprises:
retrieving, with the processor, through the LLM, in response to content of the query, a portion of the text phrases; and
generating, with a processor through the LLM, natural language sentences based on the retrieved portion of the text phrases.

8. The method of claim 6, wherein the plurality of text phrases is stored as vectorized text phrases.

9. The method of claim 6, wherein the semantic mapping information comprises at least one of: a semantic map corpus, semantic map rules, signature pairs, and signature pair functions.

10. The method of claim 6, wherein the LLM is executed within a relational database management system.

11. A non-transitory computer-readable medium encoded with a plurality of instructions executable by a processor, the plurality of instructions comprising:
instructions to receive a query associated with a plurality of data tables stored in a storage device;
instructions to process the query using a large language model (“LLM”) trained on semantic mapping information that describes relationships between data elements stored within the plurality of tables; and
instructions to generate, with the LLM, a natural language response to the query based on semantic mapping data generated from the data elements stored withing the tables.

12. The non-transitory computer-readable medium of claim 11, wherein the semantic mapping data is stored as a plurality of text phrases, wherein the at least one processor is further configured to:
Instructions retrieve, with the LLM, in response to content of the query, a portion of the text phrases; and
generate, with the LLM, natural language sentences based on the retrieved portion of the text phrases.

13. The non-transitory computer-readable medium of claim 12, wherein the plurality of text phrases is stored as vectorized text phrases.

14. The non-transitory computer-readable medium of claim 11, wherein the semantic mapping information comprises at least one of: a semantic map corpus, semantic map rules, signature pairs, and signature pair functions.

15. The non-transitory computer-readable medium of claim 11, wherein the LLM is executed within a relational database management system.
